(19) United States
(12) Patent Application Publication
(10) Pub. No.: US 2019/0145513 A1
(43) Pub. Date: May 16, 2019

(54) SHIFT DEVICE

(71) Applicant: KABUSHIKI KAISHA TOKAI RIKA DENKI SEISAKUSHO, Aichi (JP)

(72) Inventors: Hiroki ONO, Aichi (JP); Kenji NAKANISHI, Aichi (JP); Keiji KAHARA, Aichi (JP)

(73) Assignee: KABUSHIKI KAISHA TOKAI RIKA DENKI SEISAKUSHO, Aichi (JP)

(21) Appl. No.: 16/308,753

(22) PCT Filed: Jun. 12, 2017
(86) PCT No.: PCT/JP2017/021593

§ 371 Date: Dec. 10, 2018

(30) Foreign Application Priority Data
Jun. 13, 2016 (JP) 2016-117264

(51) Int. Cl. F16H 61/22; F16H 59/12

(52) U.S. Cl. CPC F16H 61/22; F16H 59/12

(57) ABSTRACT

A shift device includes a shift switch configured to be operated in a first direction to switch to a certain shift position and a switch detector that detects movement of the shift switch in the first direction. The shift device also includes a release switch that is located at a position differing from that of the shift switch and configured to be moved between a restriction position that restricts operation of the shift switch in the first direction and a release position that allows operation of the shift switch in the first direction. The shift device shifts a shift range of a transmission to a gear mode corresponding to the shift switch when the switch detector detects the movement of the shift switch in the first direction.

### TECHNICAL FIELD

The present invention relates to a shift device for a vehicle.

### BACKGROUND ART

A shift device for a vehicle that shifts gear modes of an automatic transmission is known in the art.

A shift device in patent document 1 includes a P-switch that sets the gear mode to a parking mode, an R-switch that sets the gear mode to a reverse mode, an N-switch that sets the gear mode to a neutral mode, and a D-switch that sets the gear mode to a drive mode. The P-switch, the N-switch, and D-switch are aligned and formed by push button switches that are pushed in a first direction that intersects an alignment direction in which the switches are aligned. The R-switch is a push button switch pushed in a second direction that extends in the alignment direction. The distal end of the R-switch is covered by a cover aligned with the P-switch, the N-switch, and the D-switch. The cover is pushed in the first direction and rotated about a rotation shaft arranged at an N-switch side to contact the distal end of the R-switch. After the cover contacts the distal end of the R-switch, the R-switch can be pushed in the second direction. That is, with the shift device, the cover needs to be pushed in the first direction to push the R-switch in the second direction.

### PRIOR ART LITERATURE

### Patent Literature

Patent Document 1: Japanese Laid-Open Patent Publication No. 2014-83974

### SUMMARY OF THE INVENTION

### Problem to be Solved by the Invention

In the switch device of patent document 1, the cover of the R-switch is pushed in the first direction that is the same direction as the direction in which the P-switch, the N-switch, and the D-switch are pushed. Thus, the driver may erroneously recognize that the R-switch has been pushed when only pushing the cover. This may lead to erroneous operation of the shift device.

It is an object of the present invention to provide a shift device that reduces erroneous operations.

### Means for Solving the Problem

According to one mode, a shift device includes a shift switch configured to be operated in a first direction to switch to a certain shift position, a switch detector that detects movement of the shift switch in the first direction, and a release switch that is located at a position differing from that of the shift switch and configured to be moved between a restriction position that restricts operation of the shift switch in the first direction and a release position that allows operation of the shift switch in the first direction. The shift device shifts a shift range of a transmission to a gear mode corresponding to the shift switch when the switch detector detects the movement of the shift switch in the first direction.

With this construction, the shift switch cannot be operated in the first direction unless the release switch has been operated and moved from the restriction position to the release position. That is, the shift switch cannot be operated in isolation. This reduces erroneous shifting of the gear modes by unintentional operation of the shift switch. Further, the release switch is located at a position differing from that of the shift switch and thus different fingers are required for operations. Thus, the requirement of intentional operations with different fingers also reduces erroneous operations.

In the above construction, it is preferable that the release switch is configured to be moved between the restriction position and the release position for the shift switch when the release switch is operated in a second direction, which differs from the first direction.

With this construction, the release switch and the shift switch are located at different positions and operated in different directions, requiring different fingers for operations. This requirement of intentional operations with different fingers reduces erroneous operations.

In the above construction, it is preferable that the first direction in which the shift switch is operated intersects the second direction in which the release switch is operated.

With this construction, a pinching operation with fingers on one hand on the shift switch and the release switch can easily be performed. This improves operability.

According to another mode, a shift device includes a shift switch configured to be operated in a first direction to switch to a certain shift position, a switch detector that detects movement of the shift switch in the first direction, and a proximity sensor that is located at a position differing from that of the shift switch and configured to detect nearby presence of an electrical conductor. The shift device shifts a shift range of a transmission to a gear mode corresponding to the shift switch when the switch detector detects the movement of the shift switch in the first direction in a state in which the proximity sensor detects nearby presence of the electrical conductor.

With this construction, the operation of the shift switch and arrangement of an electrical conductor such as a hand nearby the proximity sensor can both be performed to shift a gear mode in correspondence with the shift switch. In other words, erroneously operating only the shift switch does not shift the gear modes. This reduces unintentional shift of the gear mode.

In the above construction, it is preferable that the proximity sensor is arranged inside a housing that accommodates the shift switch.

This construction has a high degree of freedom for the location of the shift device in a vehicle.

In the above construction, it is preferable that the shift device shifts the shift range of the transmission to the gear mode corresponding to the shift switch when the switch detector detects the movement of the shift switch in the first direction in a state determined from a detection result of the proximity sensor that a sliding operation has been performed with the electrical conductor.

With this construction, in order to shift gear modes, it is required that the electrical conductor detected by the proximity sensor intentionally performs a sliding operation. This further reduces erroneous operations.

In the above construction, it is preferable that the shift device further includes a release switch configured to be moved between a restriction position, which restricts operation of the shift switch in the first direction, and a release position, which allows operation of the shift switch in the first direction when the proximity sensor detects nearby presence of the electrical conductor.

With this construction, the shift switch cannot be operated unless the proximity sensor detects nearby presence of an electrical conductor. That is, the shift switch cannot be operated in isolation. This reduces erroneous shifting of gear modes by unintentional operation of the shift switch.

### Effect of the Invention

The shift device of the present invention reduces erroneous operations.

### BRIEF DESCRIPTION OF THE DRAWINGS

FIG. 1 is a perspective view of a shift device.

FIG. 2 is an exploded perspective view of the shift device.

FIG. 3 is a schematic cross-sectional view showing part of the shift device.

FIG. 4 is a schematic cross-sectional view showing part of the shift device in a state in which an R-switch is pushed.

FIG. 5 is a schematic cross-sectional view showing part of the shift device before the R-switch and a lock release switch are pushed.

FIG. 6 is a schematic cross-sectional view showing part of the shift device in a state in which the R-switch and the lock release switch are pushed.

FIG. 7 is a side view showing a shift device of a modified example.

FIG. 8 is a schematic cross-sectional view showing part of the shift device in FIG. 7 before an R-switch and a lock release switch are operated.

FIG. 9 is a schematic cross-sectional view showing part of the shift device in FIG. 7 in a state in which the R-switch and the lock release switch are operated.

FIG. 10 is a schematic cross-sectional view showing part of a shift device of a modified example.

FIG. 11 is a schematic cross-sectional view showing part of the shift device in FIG. 10.

FIG. 12 is a schematic cross-sectional view showing part of a shift device of a modified example

FIG. 13 is a schematic cross-sectional view showing part of the shift device in FIG. 12.

FIG. 14 is a perspective view showing a shift device of a modified example.

FIG. 15 is a perspective view showing a shift device of a modified example.

### EMBODIMENTS OF THE INVENTION

A shift device in accordance with one embodiment will now be described with reference to the drawings.

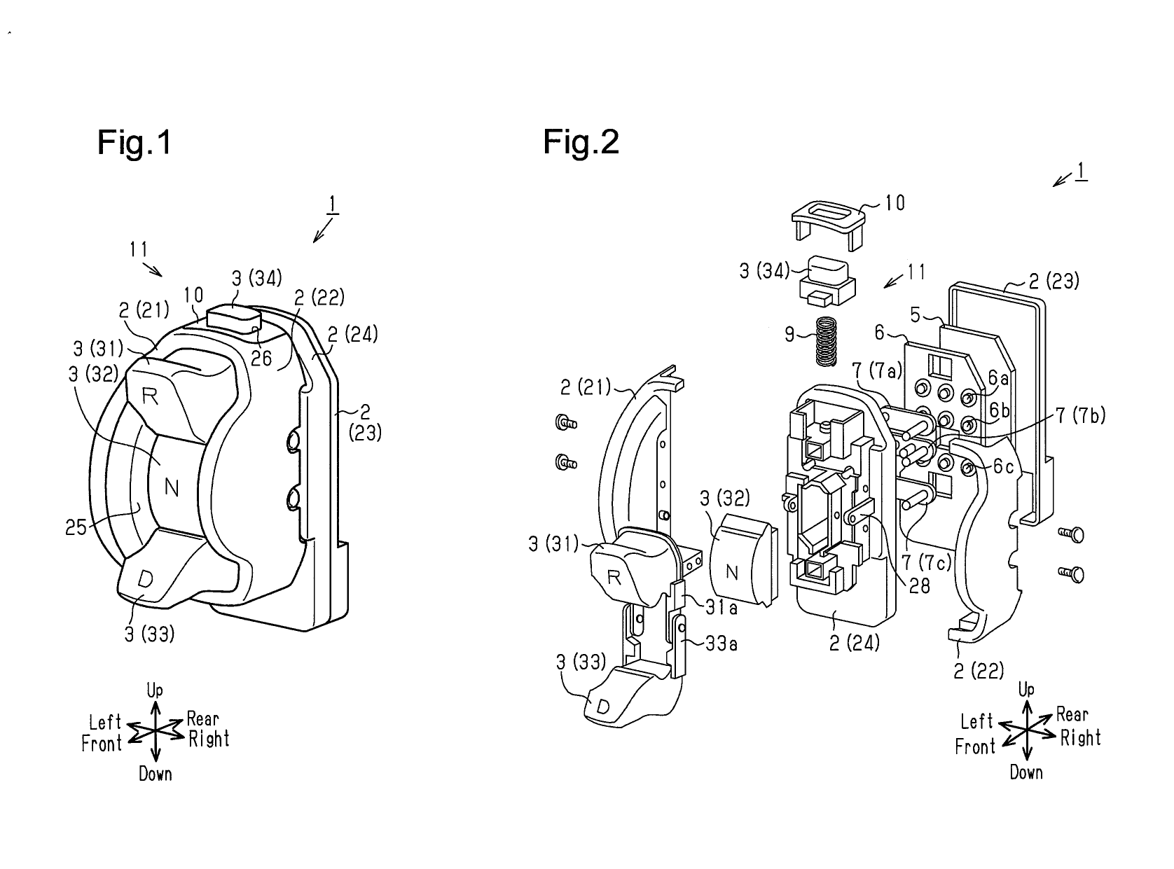

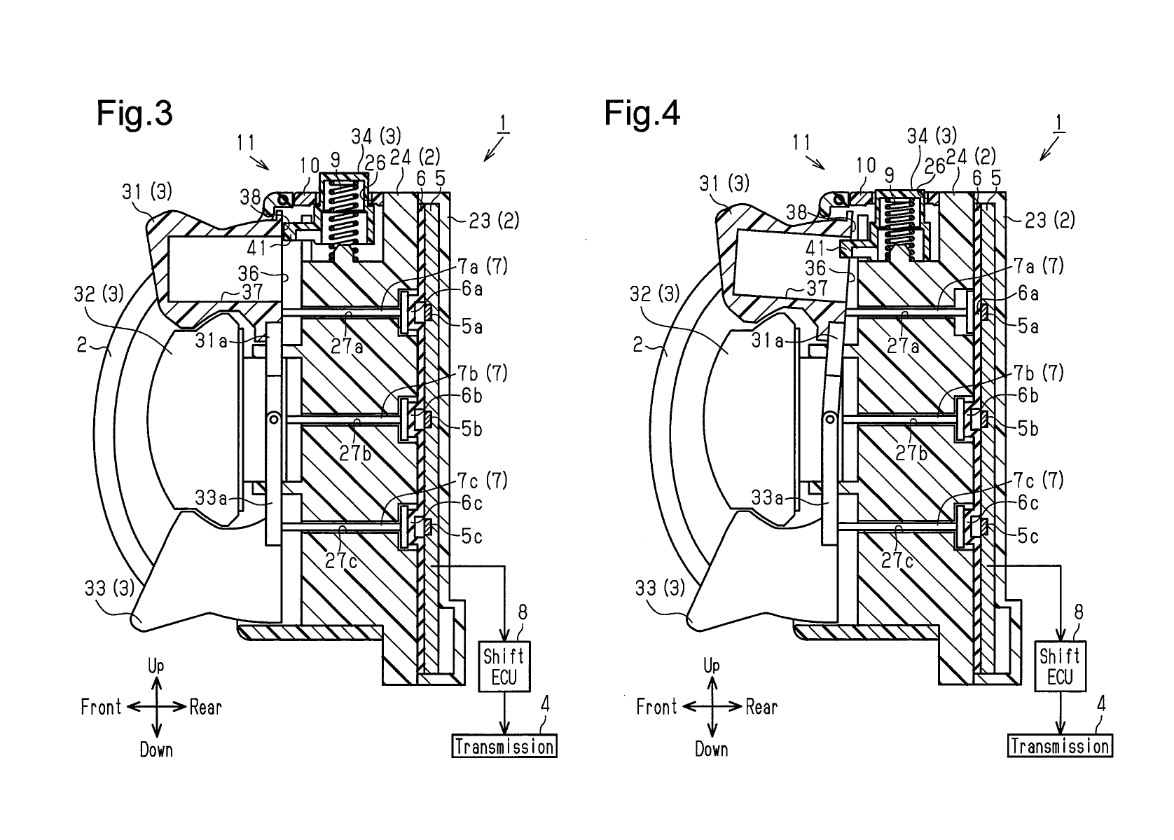

As shown in FIG. 1, a shift device 1 includes a housing 2 and a plurality of operation portions 3 that are pushed to be operated. When the operation portions 3 are operated, the shift device 1 shifts gear modes of a transmission 4 (automatic transmission) installed in a vehicle (refer to FIG. 3). For example, the shift device 1 is located inside a vehicle in a center cluster, a center console, an instrument panel, or near the above components.

As shown in FIG. 2, the housing 2 includes left and right segments 21 and 22, a rear segment 23, and a base plate 24. The left and right segments 21 and 22 respectively cover a left side and a right side of the base plate 24. The rear segment 23 covers a rear side of the base plate 24. Accordingly, as shown in FIG. 1, the housing 2 includes a front opening 25 and an upper opening 26.

As shown in FIG. 2, the shift device 1 includes a substrate 5, a contact rubber 6, and contact members 7 between the rear segment 23 and the base plate 24.

As shown in FIG. 3, the substrate 5 includes fixed contacts 5a, 5b, and 5c that are exposed toward the front and aligned in a vertical direction. The substrate 5 is coupled to a front surface of the rear segment 23. Further, the substrate 5 is electrically connected to a shift ECU 8 that shifts gear modes of the transmission 4. The shift ECU 8 shifts gear modes of the transmission 4 based on a contact state of the fixed contacts 5a, 5b, and 5c relative to corresponding movable contacts, which will be described later. As shown in FIG. 3, the shift ECU 8 may be arranged outside the substrate 5 or on the substrate 5. The fixed contact 5a serves as a switch detector.

The contact rubber 6 covers a front surface of the substrate 5. The contact rubber 6 includes click domes 6a, 6b, and 6c that are projected forward and aligned in the vertical direction. The click domes 6a, 6b, and 6c respectively cover the fixed contacts 5a, 5b, and 5c. Further, metal material (not shown) is fixed to rear surfaces of the click domes 6a, 6b, and 6c to close an internal circuit on the substrate 5 when contacting the corresponding fixed contacts 5a, 5b, and 5c. The metal material corresponds to a movable contact.

The contact members 7 refer to contact members 7a, 7b, and 7c that are aligned in the vertical direction. The contact members 7 extend in a front-rear direction. The contact members 7a, 7b, and 7c are arranged so as to correspond with the click domes 6a, 6b, and 6c, respectively. Further, the contact members 7a, 7b, and 7c are inserted into through holes 27a, 27b, and 27c that extend through the base plate 24 in the front-rear direction and are aligned in the vertical direction. The contact members 7a, 7b, and 7c include distal ends that are located in front of the base plate 24.

As shown in FIG. 1, the shift device 1 includes an R-switch 31, an N-switch 32, a D-switch 33, and a lock release switch 34 serving as the operation portions 3.

The R-switch 31, the N-switch 32, and the D-switch 33 are exposed from the front opening 25 of the housing 2 and aligned in the vertical direction.

As shown in FIGS. 2 and 3, the R-switch 31 includes a rear end from which a support piece 31a extends downward. The D-switch 33 includes a rear end from which a support piece 33a extends upward. The support pieces 31a and 33a each include a distal end that are rotatably supported by a support 28 arranged on the base plate 24. That is, the R-switch 31 and the D-switch 33 respectively rotate about the distal ends of the support pieces 31a and 33a. The R-switch 31 serves as a shift switch.

The N-switch 32 is supported by the base plate 24 sandwiched between the R-switch 31 and the D-switch 33 in the vertical direction so as to be movable in the front-rear direction

As shown in FIGS. 3 and 4, the rear ends of the R-switch 31, the N-switch 32, and the D-switch 33 contact the distal ends of the contact members 7a, 7b, and 7c, respectively. Accordingly, the R-switch 31, the N-switch 32, and the D-switch 33 can be pushed rearward by the contact members 7a, 7b, and 7c in correspondence with the elastic deformation of the click domes 6a, 6b, and 6c, respectively. When the pushing is canceled, the R-switch 31, the N-switch 32, and the D-switch 33 move forward in accordance with the elastic recovery of the click domes 6a, 6b, and 6c returning to the positions before the pushing (original position). The R-switch 31 and the D-switch 33 are restricted from moving further forward from the original positions because of engagement relationship with the housing 2 (not shown). Further, the N-switch 32 is restricted from moving further forward from the original position because of the projection-recess relationship of the R-switch 31 and the D-switch 33. The R-switch 31 is operated in an operation direction (front-rear direction in the present embodiment) that corresponds to a first direction.

As shown in FIGS. 3 to 6, the R-switch 31 has a rear end surface 36 including a lock release groove 37 and a flange 38 that continuously extends upward from the rear end surface.

As shown in FIGS. 2 to 6, the lock release switch 34 is arranged in the upper opening 26 of the housing 2 together with a cap 10 in a state elastically compressing a recovery spring 9 with the upper part of the base plate 24. The cap 10 restricts upward movement of the lock release switch 34 beyond a lock position, which will be described later. Further, the cap 10 restricts movement of the lock release switch 34 in the front-rear direction and a sideward direction. The direction connecting the lock position and an unlock position of the lock release switch 34 (vertical direction in the present embodiment) corresponds to a second direction.

Further, the lock release switch 34 includes a lower end from which a lock projection 41 projects forward. The lock release switch 34 moves between the lock position, where the lock projection 41 is located behind the flange 38 and the unlock position, where the lock projection 41 is located below the lock position and behind the lock release groove 37. The lock release switch 34 moves from the lock position to the unlock position when pushed downward against the elastic force of the recovery spring 9. Further, when the pushing is canceled, the lock release switch 34 returns from the unlock position to the lock position (original position) in accordance with the resiliency of the recovery spring 9. The cap 10 restricts upward movement of the lock release switch 34 beyond the lock position. The R-switch 31 and the lock release switch 34 cooperate to construct a lock mechanism 11. The lock position of the lock release switch 34 corresponds to a restriction position, and the unlock position corresponds to a release position.

The operation and advantages of the shift device 1 will now be described.

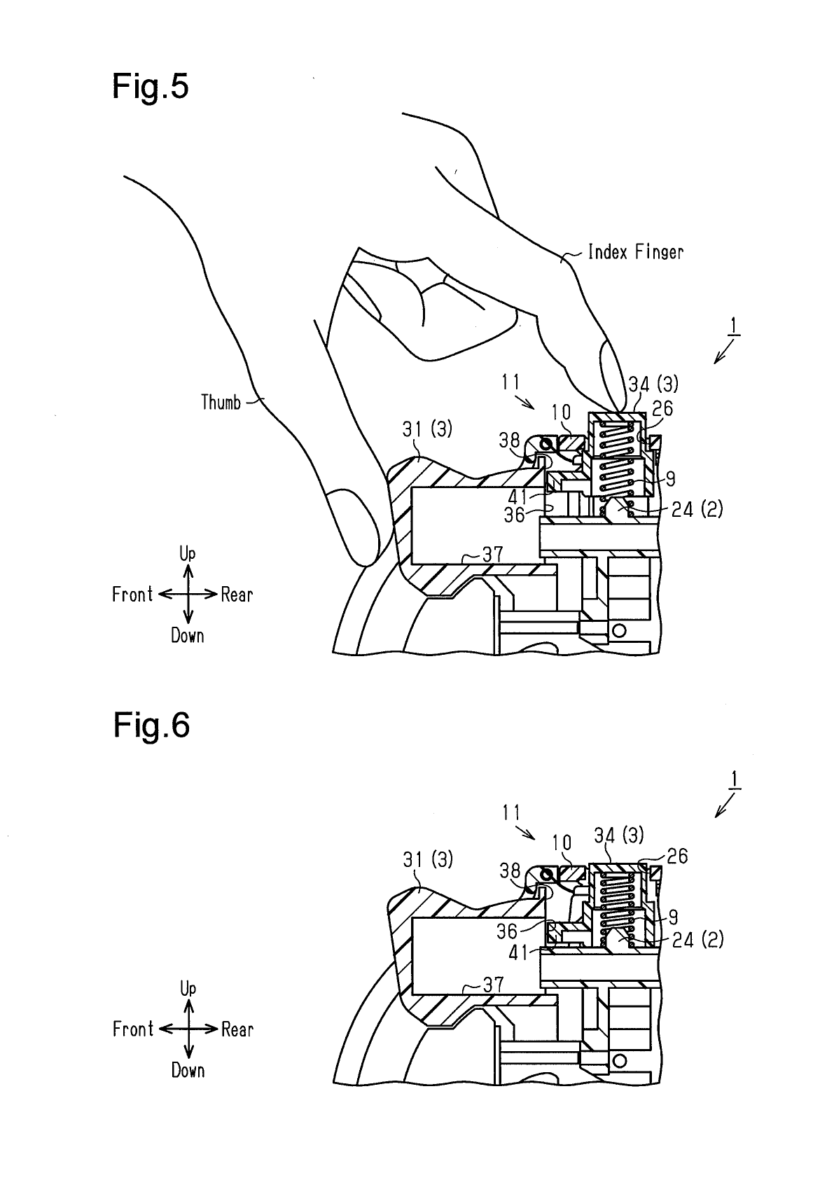

The lock release switch 34 moves between the lock position, where the lock projection 41 is located behind the flange 38, as shown in FIG. 5, and the unlock position, where the lock projection 41 is located below the lock position and behind the lock release groove 37, as shown in FIG. 6.

As shown in FIG. 5, when the lock release switch 34 is located at the lock position, the lock projection 41 is located in a path along which the flange 38 moves when the R-switch 31 is pushed. Thus, the R-switch 31 cannot be pushed.

As shown in FIG. 6, when the lock release switch 34 is at the unlock position, the lock projection 41 is not located in the path along which the flange 38 moves when the R-switch 31 is pushed. This allows the R-switch 31 to be pushed. When the R-switch 31 is pushed, the lock projection 41 enters the lock release groove 37.

In this manner, to push the R-switch 31, the lock release switch 34 needs to be pushed first. That is, to push the R-switch 31, it is required to perform a two-step operation including a prior operation of the lock release switch 34 for canceling the movement restriction of the R-switch 31. This reduces unintended erroneous operations performed on the R-switch 31.

In a state in which the lock release switch 34 is not pushed, the R-switch 31 cannot to be pushed. Thus, it is easily recognizable whether or not the R-switch 31 has been operated. This allows for determination of whether or not the gear mode has been switched to the desired one and improves operability.

Further, the R-switch 31 is exposed to the outside and thus whether or not the R-switch 31 has been pushed can easily be recognized.

The direction in which the lock release switch 34 is pushed (downward in vertical direction) differs from the direction in which the R-switch 31 is pushed (rearward in front-rear direction). This further reduces unintended erroneous operations performed on the R-switch 31. Moreover, the direction in which the lock release switch 34 is pushed intersects the direction in which the R-switch 31 is pushed. Accordingly, as shown in FIG. 5, a pinching operation with fingers on one hand (for example, with thumb and index finger) can easily be performed. This also improves operability.

Further, since the lock release switch 34 is movable, there is no need for a component that detects the operation performed on the lock release switch 34. This reduces the number of components constructing the shift device 1. Consequently, the shift device 1 may easily be reduced in size.

The above embodiment may be modified as follows.

The lock release switch 34 does not necessarily have to be a switch that is pushed as described in the above embodiment.

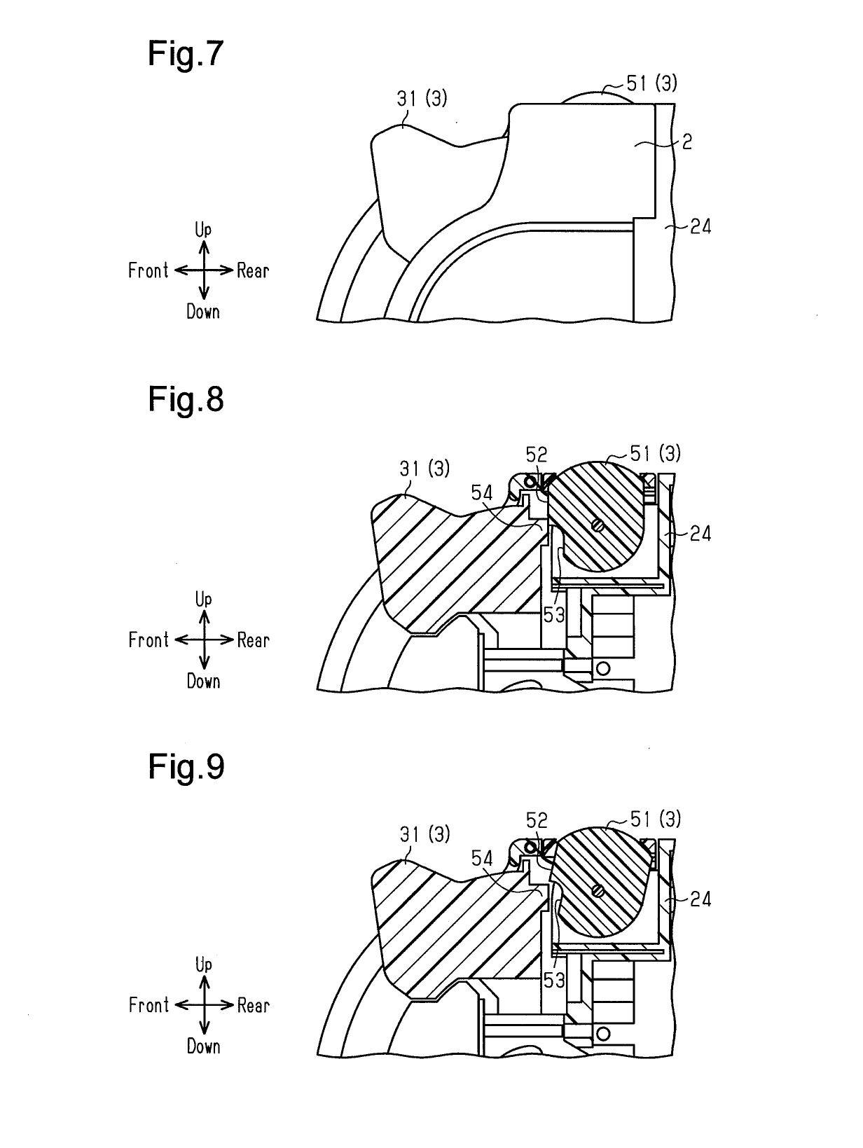

For example, as shown in FIGS. 7 to 9, a lock release switch 51 is rotatably supported on the upper part of the base plate 24 partially exposed to the outside from the upper opening 26 of the housing 2. The lock release switch 51 includes a front surface that is a restriction surface 52. A lower part of the restriction surface 52 includes a cutout 53. The lock release switch 51 moves between a lock position, where the restriction surface 52 is located behind an engagement projection 54 that projects from the rear surface of the R-switch 31, and an unlock position, where the restriction surface 52 and the cutout 53 are moved in a clockwise direction from the lock position and the cutout 53 is located behind the engagement projection 54. The lock release switch 51 is continuously biased from the unlock position toward the lock position by an elastic component, for example a torsion spring (not shown). With this construction, the same advantages as the above embodiment can also be obtained. The R-switch 31 and the lock release switch 51 construct a first lock mechanism.

In the above modified example, the lock release switch 51 unlocks the R-switch 31 when rotated in the clockwise direction relative to the plane of the drawing. However, the R-switch 31 may be unlocked by rotating the lock release switch 51 in a counterclockwise direction. In such a case, the cutout 53 is arranged at an upper side of the restriction surface 52.

In the above embodiment, the R-switch 31 is physically restricted from being pushed. However, the R-switch 31 may be electrically restricted from being pushed.

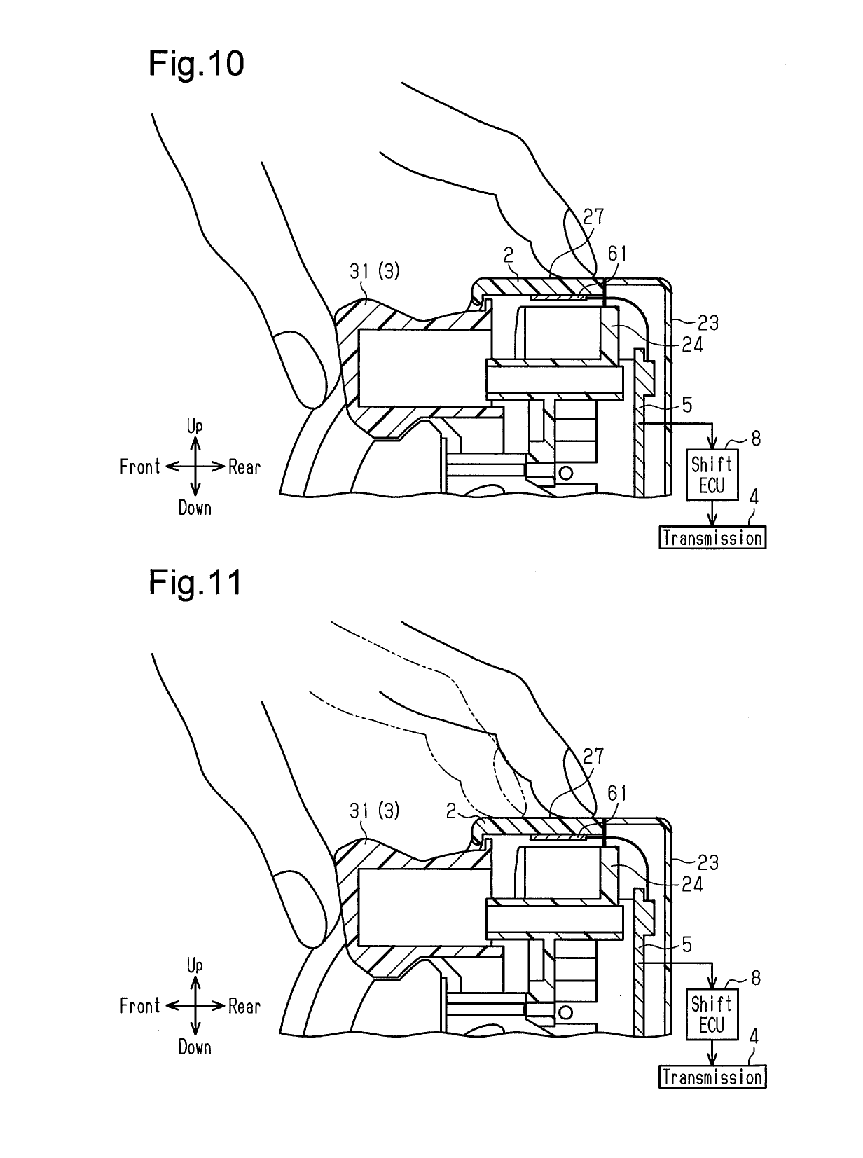

For example, as shown in FIGS. 10 and 11, instead of the upper opening 26 and the lock release switch 34 of the above embodiment, a proximity sensor 61 is arranged on an inner surface of the upper part of the housing 2. Further, the proximity sensor 61 is electrically connected to the substrate 5. The ECU 8, which is connected to the substrate 5, allows the pushing of the R-switch 31 when the proximity sensor 61 detects nearby presence of an electrical conductor (finger).

With such a construction, an outer shape of the shift device does not change. This increases the degree of freedom for the location of the shift device in a vehicle. Further, with this construction, the R-switch 31 can always be pushed. Accordingly, it is preferable to include a notification portion that issues, for example, an audio signal or visual information when the R-switch 31 is operated. The information issued by the notification portion allows a user to recognize whether or not the R-switch 31 has been properly operated.

In the above modified example, as shown in FIG. 11, the shift ECU 8 may have the proximity sensor 61 detect sliding operation of an electrical conductor (finger) along an upper outer surface 27. Further, the shift ECU 8 may allow the pushing of the R-switch 31 only when sliding operation has been detected. In this way, operation of the upper outer surface 27 needs to be more intentional than the above modified example for the pushing of the R-switch 31 to be allowed. This further reduces unintended erroneous operations performed on the R-switch 31.

In the above modified example, the proximity sensor 61 is employed and the pushing of the R-switch 31 is always allowed. However, the pushing of the R-switch 31 may be restricted even when the proximity sensor 61 is employed.

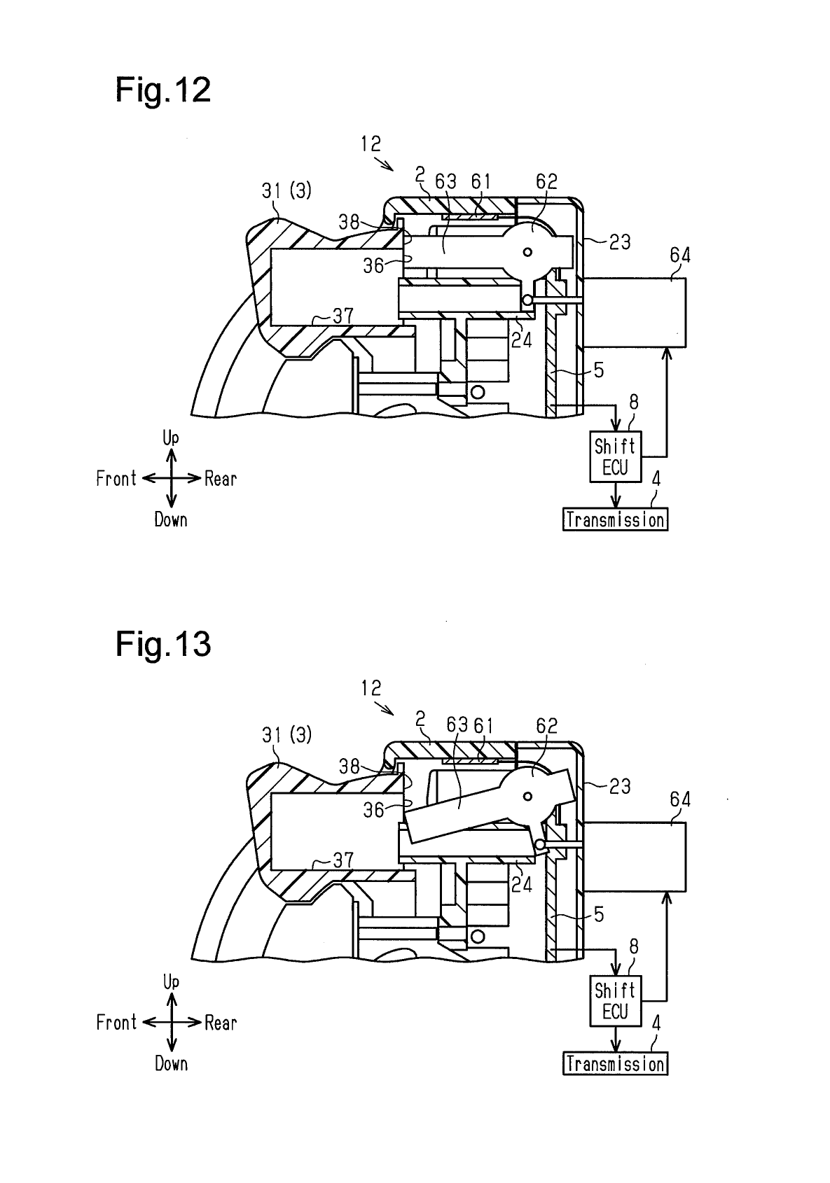

For example, as shown in FIGS. 12 and 13, a lock link 62 is rotatably supported by the upper part of the base plate 24. The lock link 62 includes a contact portion 63 that extends forward. The lock link 62 is rotated and moved between a lock position, where the contact portion 63 is located behind the flange 38 of the R-switch 31, and an unlock position, where the contact portion 63 is located below the lock position and behind the lock release groove 37 of the R-switch 31. The shift ECU 8 drives a solenoid 64 to rotate the lock link 62 between the lock position and the unlock position. When the proximity sensor 61 detects nearby presence of an electrical conductor (finger), the shift ECU 8 drives the solenoid 64 to move the lock link 62 from the lock position to the unlock position. Further, when the electrical conductor (finger) is no longer nearby the proximity sensor 61, the shift ECU 8 drives the solenoid 64 to move the lock link 62 from the unlock position to the lock position. With such a construction, the same advantages as the above embodiment can also be obtained. In the present embodiment, the lock link 62 corresponds to a release switch. The R-switch 31 and the lock link 62 construct a lock mechanism 12.

In this way, with the arrangement of the proximity sensor on the inner surface of the housing 2, the lock release switch 34 does not project from the housing 2. This differs from the above embodiment and eliminates the need to take into consideration the projection. Thus, the degree of freedom is high for the location of the shift device 1 in a vehicle.

The proximity sensor in the above modified examples may perform detection in any manner, such as an inductive proximity sensor that detects magnetic loss on the surface of a conductor (surface of housing 2 in this case) caused when overcurrent is generated by an nearby presence of an electrical conductor or a capacitive proximity sensor that detects changes in the capacitance between an electrical conductor and the sensor. The concept of nearby presence includes contact with the sensor as well as being close to but not contacting the sensor.

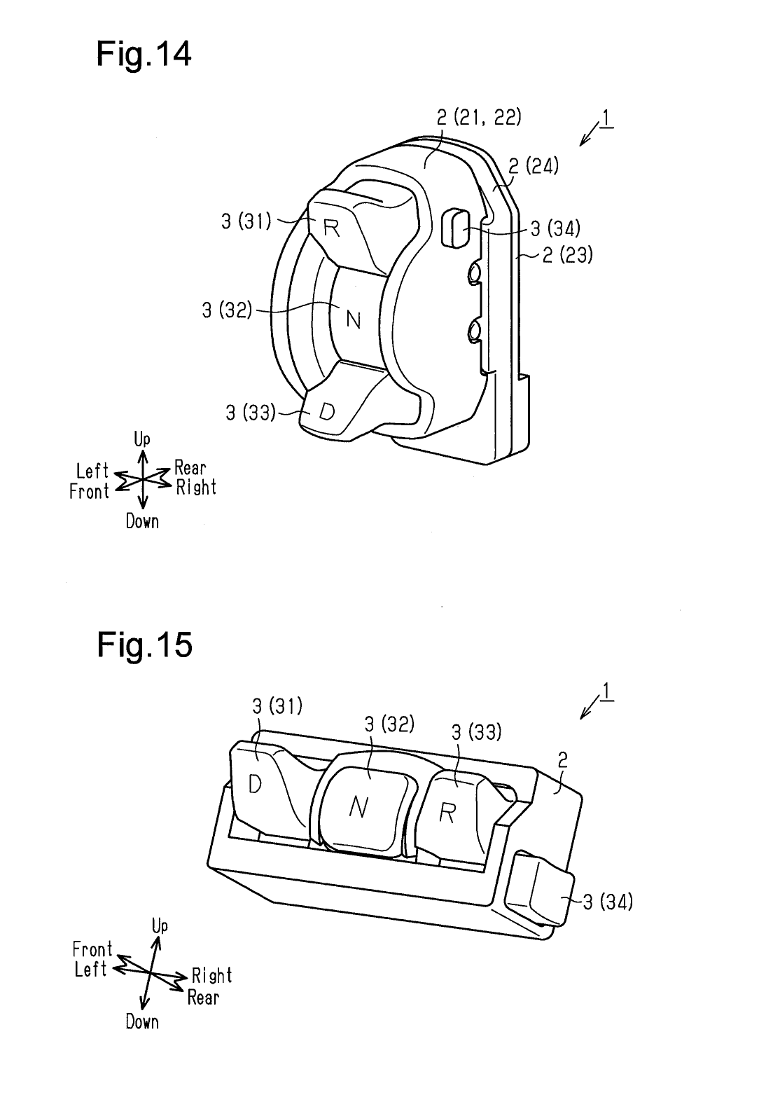

In the above embodiment, the lock release switch 34 is arranged on the upper part of the housing 2. However, the lock release switch 34 may be arranged on the right side of the housing 2, as shown in FIG. 14, or on the left side (not shown). With this construction, the same advantages as the above embodiment can also be obtained. Instead of the lock release switch 34, the proximity sensor 61 may be arranged like in the above modified example.

In the above embodiment, the R-switch 31, the N-switch 32, and the D-switch 33 are aligned in the vertical direction. However, the R-switch 31, the N-switch 32, and the D-switch 33 may be aligned in the sideward direction, as shown in FIG. 15. Further, the lock release switch 34 may be arranged at a different location. Instead of the lock release switch 34, the proximity sensor 61 may be arranged like in the above modified example.

In the above embodiment, shifting positions of the R-switch 31, the N-switch 32, and the D-switch 33 may be changed.

In the above embodiment, the R-switch 31 is switched to be locked and unlocked. However, other switches may be switched to be locked and unlocked.

In the above embodiment, the R-switch 31, the N-switch 32, and the D-switch 33 are used. However, any number of switches may be used to shift the gear modes. For example, a P-switch may be arranged to shift the gear mode to parking.

1. A shift device comprising:
a shift switch configured to be operated in a first direction to switch to a certain shift position;
a switch detector that detects movement of the shift switch in the first direction; and
a release switch that is located at a position differing from that of the shift switch and configured to be moved between a restriction position that restricts operation of the shift switch in the first direction and a release position that allows operation of the shift switch in the first direction,
wherein the shift device shifts a shift range of a transmission to a gear mode corresponding to the shift switch when the switch detector detects the movement of the shift switch in the first direction.

2. The shift device according to claim 1, wherein the release switch is configured to be moved between the restriction position and the release position for the shift switch when the release switch is operated in a second direction, which differs from the first direction.

3. The shift device according to claim 2, wherein the first direction in which the shift switch is operated intersects the second direction in which the release switch is operated.

4. A shift device comprising:
a shift switch configured to be operated in a first direction to switch to a certain shift position;
a switch detector that detects movement of the shift switch in the first direction; and
a proximity sensor that is located at a position differing from that of the shift switch and configured to detect nearby presence of an electrical conductor,
wherein the shift device shifts a shift range of a transmission to a gear mode corresponding to the shift switch when the switch detector detects the movement of the shift switch in the first direction in a state in which the proximity sensor detects nearby presence of the electrical conductor.

5. The shift device according to claim 4, wherein the proximity sensor is arranged inside a housing that accommodates the shift switch.

6. The shift device according to claim 5, wherein the shift device shifts the shift range of the transmission to the gear mode corresponding to the shift switch when the switch detector detects the movement of the shift switch in the first direction in a state determined from a detection result of the proximity sensor that a sliding operation has been performed with the electrical conductor.

7. The shift device according to claim 5, further comprising a release switch configured to be moved between a restriction position, which restricts operation of the shift switch in the first direction, and a release position, which allows operation of the shift switch in the first direction when the proximity sensor detects nearby presence of the electrical conduc
